(19) United States
(12) Patent Application Publication
(10) Pub. No.: US 2008/0108374 A1
(43) Pub. Date: May 8, 2008

(54) Standalone positioning in 3G UMTS systems

(75) Inventors: Michelle H. Xiong, Vernon Hills, IL (US); Ping Wu, Hoffman Estates, IL (US)

Correspondence Address: BRINKS HOFER GILSON & LIONE, P.O. BOX 10395, CHICAGO, IL, 60610, US

(73) Assignee: Motorola, Inc.

(21) Appl. No.: 11/592,462

(22) Filed: Nov. 2, 2006

(51) Int. Cl. H04Q 7/20; H04M 1/00

(52) U.S. Cl. 455/456.6; 455/550.1

(57) ABSTRACT

A communications device (101) for a 3G network (115) includes a user equipment (UE) processor (206) able to determine a standalone location based on a Standalone Position Method type or standalone position method transmitted in a radio resource control (RRC) measurement control message. The 3G network (115) may command the UE processor (206) to use a standalone positioning method by transmitting a standalone position method type or standalone position method command to the communications device (101). The UE processor (206) determines the standalone location using an internal positioning module (212) such as an embedded GPS chipset, or an external positioning module (218), such as a Bluetooth accessory.

### BACKGROUND

The invention relates to third generation (3G) radio communication systems. In particular, the invention relates to positioning methods in 3G radio communications systems.

Location determination is becoming an increasingly important capability for some electronic devices, such as cellular telephones, personal digital assistants (PDA's), and portable computers, as well as other devices. Separate from the direct benefits associated with knowing one's current location, many venders are introducing or contemplating location based services or solicitations, which can be selectively made available to the user of an electronic device, and which are dependent upon the device's current and/or anticipated location. Still other location based features and/or capabilities, relative to portable electronic devices, are being mandated by governmental agencies. One such example of a location based feature, which has been mandated by the US Federal Communication Commission (FCC), includes a feature known as E911.

In the current 3G Universal Mobile Telecommunications System (UMTS) system, a network cannot command a user equipment (UE) device to do a Standalone Positioning Measurement even though the UE is capable of a Standalone Positioning method. Therefore, the network can not maximize a UE's Positioning capability. When a 3G Network-based or UE-Based Location Service is not available, position determination is not possible for emergency calls, even though the UE is capable of providing location information using a Standalone Positioning method.

U.S. Patent Publication 2006/0135176, which is incorporated by reference herein, discloses a method and controller for selecting between a plurality of different position determination approaches, where in at least some instances a selection is made between multiple mobile station based location determination approaches, as well as in other instances additional network based location determination approaches. In at least some instances, the selection between available mobile station based location determination approaches is based upon the availability and/or the receipt of assistance data from the network.

In 3G UMTS system (3GPP 25.331), the Standalone Positioning method is considered/indicated in Positioning Capability through the Radio Resource Control (RRC) Connection Setup procedure[UE Capability Enquiry procedure. However in 3G UMTS system, the Standalone Positioning method is not considered as a Positioning method type in an RRC Measurement Control message. Currently, UE-Positioning Method Types are defined as: UE-Assisted, UE-Based, UE-BasedPreferred and UE-AssistedPreferred.

Also, when a Universal Terrestrial Radio Access Network (UTRAN) supports Assisted GPS (AGPS) service, the conventional methods do not provide a way for a UE to fall back to a standalone location method when there is not enough assistance data. In addition, conventional methods do not provide a procedure for a UE to determine when the UE should fall back to using the standalone location method.

### BRIEF DESCRIPTION OF THE DRAWINGS

Embodiments of the present invention are now described, by way of example only, with reference to the accompanying figures in which:

FIG. 1 illustrates an example 3G network.

FIG. 2 illustrates an example communication device

FIG. 3 is an example process that enables a standalone positioning measurement in a 3G network.

FIG. 4 is a second example process that enables a standalone positioning measurement in a 3G network.

### DETAILED DESCRIPTION

The present disclosure is defined by the appended claims. This description summarizes some aspects of the present embodiments and should not be used to limit the claim.

While the present disclosure may be embodied in various forms, there are shown in the drawings and will hereinafter be described some exemplary and non-limiting embodiments, with the understanding that the present disclosure is to be considered an exemplification of the disclosure and is not intended to limit the invention to the specific embodiments illustrated.

In this application, the use of the disjunctive is intended to include the conjunctive. The use of definite or indefinite articles is not intended to indicate cardinality. In particular, a reference to “the” object or “a and an” object is intended to denote also one of a possible plurality of such objects.

In a preferred embodiment, a 3G network Positioning Method type is disclosed, a Standalone Positioning method, and a determination method for UE-Based or Standalone measurements when a UE is capable of both UE-Based and Standalone Positioning methods by using conventional data fields without affecting the existing positioning methods.

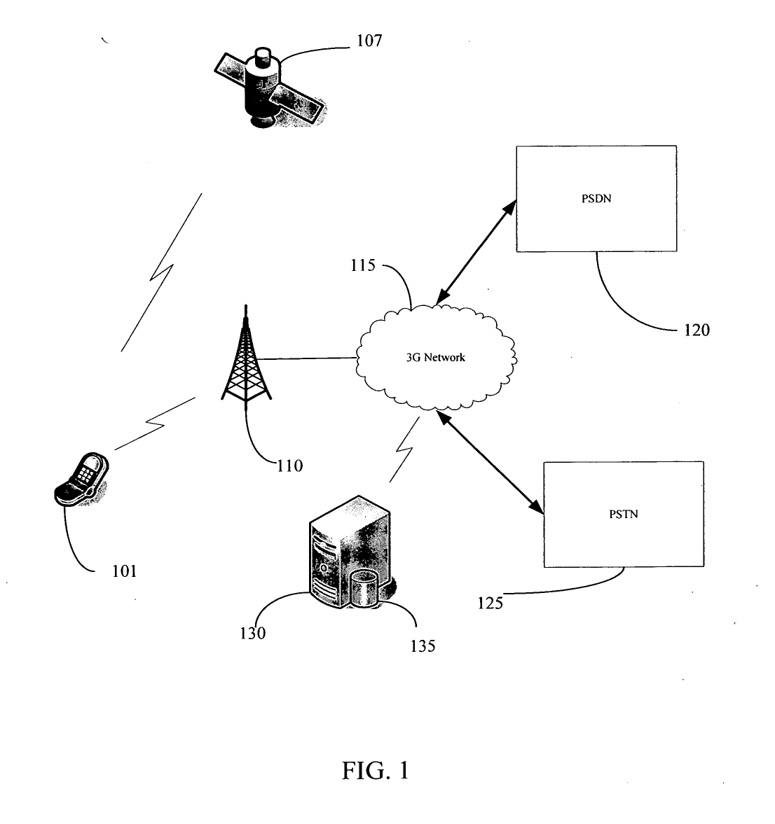

FIG. 1 is an example schematic block diagram of a 3GPP network 100. The wireless communications network includes a plurality of wireless communication device (user equipment, or UE) 101, a satellite 107, a base transceiver station (BS) 110, a 3G network 115, a Public Switched Data Network (PSDN) 120, a Public Switched Telephone Network (PSTN) 125, a reference location server 130, and a data structure 135.

The UE 101 can be any suitable device, which is capable of movement relative to one or more reference locations. In the illustrated embodiment, at least one example of a reference location includes a satellite 107, wherein at least some instances the satellite 107 represents one of a plurality of satellites, which are sometimes referred to as a constellation. However in some embodiments, a BS 110 may additionally or alternatively function as a reference location, where similar to the satellite 107, the BS 110 can represent one of a plurality of base stations. Generally, the satellites, base stations, etc., which function as reference locations, can be used with the UE 101 to determine the location of the UE 101, which often includes some ability to transmit and/or receive signals communicated between the UE 101 and the reference location(s).

The UE 101 may be a cellular telephone configured to operate with the 3G UMTS protocol, or other wireless Code Division Multiple Access (W-CDMA) protocols. The UE 101 may include other devices that transmit and receive data signals interoperable with the 3GPP protocol.

In at least some embodiments, the UE 101 can be a radio telephone, such as a cellular telephone, which can wirelessly communicate with a 3G network 115 via the BS 110, or other type of wireless transceiver, which is communicatively coupled to the 3G network 115. However one skilled in the art will appreciate that the UE 101 could alternatively be representative of other types of devices, such as a personal digital assistant (PDA), a cordless telephone, a portable computer, or a dedicated global positioning system (GPS) terminal, which may have a global positioning system receiver or transceiver incorporated therein. Furthermore, the UE 101 could be a hand-held device, or a device mounted in or on a vehicle, such as an automobile.

The BS 110 is the section of the network 100 which handles traffic and signaling between a mobile phone and a Network Switching Subsystem, such as the 3G network 115. The BS 110 transcodes speech channels, allocates radio channels to mobile phones, handles paging, quality management of transmission and reception over the air interface, and many other tasks related to the radio network. The BS 110 contains radio frequency transmitters and receivers used to communicate directly with the UE 101.

The 3G network 115 includes components that connect the UE 101 and the BS 110 with other components, such as the PSDN 120 and the PSTN 125. The 3G network 115 includes support nodes, servers, and gateways operable to transmit the data carried within the 3G network 115 and between the UE 101 and the PSDN 120 and the PSTN 125.

In addition to infrastructure which supports communication within a network, the 3G network 115 will often include and link together other devices, such as other mobile and non-mobile stations, where some of the devices might function as interfaces for one or more users for sending and receiving information via the 3G network 115. Other devices, such as some servers, may supply user accessible content, which is of direct interest to the user. In other instances, some servers may supply information, which is useful in managing the operation of the network. The Internet may also be accessible as a source/destination of information, such as by using TCP/IP or VoIP.

In at least one embodiment, a reference location server 130 is coupled to the 3G network 115. The reference location server 130 may store or supply data from a data structure 135 containing assistance data, such as data relative to the reference locations that can be used in a location determination of a mobile station. In some instances, the reference location server can be incorporated within a position determining entity, and may similarly include a global positioning system receiver/transceiver for separately communicating with one or more of the corresponding reference locations. While the BS 110 and reference location server 130 are illustrated separate from the 3G network 115, in many instances the base station 110 and the reference location server 130 are understood to be part of the 3G network 115 and/or the network infrastructure.

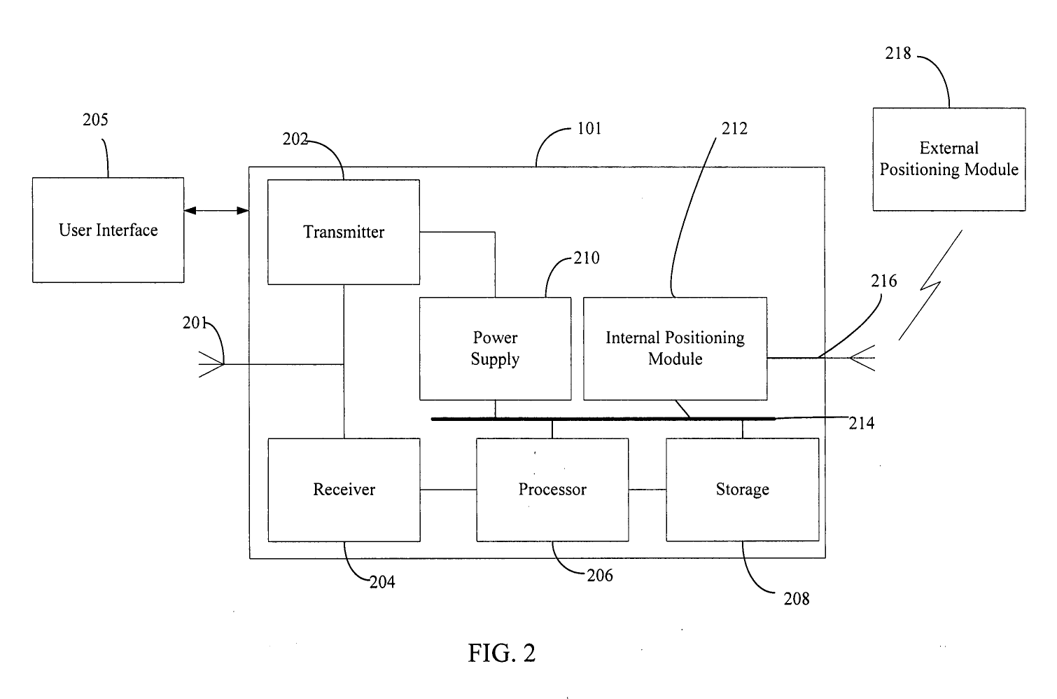

FIG. 2 illustrates a schematic block diagram of an example wireless communication device 101. The wireless communication device 101 includes transceiver antenna 201, a transmitter 202, a receiver 204, a processor 206, a storage 208, a power supply 210, an internal positioning module 212, a positioning module receiving antenna 216, and an external positioning module 218. In an exemplary embodiment, the antenna 201 may be coupled to both the transmitter 202 and the receiver 204, or the transmitter 202 and the receiver 204 may be connected to respective antenna units. In another exemplary embodiment, the positioning module 212 may be coupled with the receiving antenna 216. Still further, in some embodiments, a user interface 205 may be similarly coupled to the wireless communication device 101. Examples of elements, which can form all or parts of the user interface, include user actuatable keys, displays, speakers, and microphones, as well as other elements which facilitate interaction between the device and the user. In some instances the display may be touch sensitive.

In another exemplary embodiment, the processor 206, the storage 208, the power supply module 210, and the positioning module 212 are coupled to each other through a communications bus 214. The communications bus 214 is operable to transmit control and communications signals from and between the components connected to the bus 214, such as power regulation, memory access instructions, channel control, and other system information. The processor 206 is coupled to the receiver 204, and the transmitter 202 is coupled to the receiver 204 and to the processor 206.

The processor 206 is configurable to format and create packets of data to transmit using the transmitter 202. In the illustrated embodiment, the execution of at least some of the one or more sets of prestored instructions included with the storage 208 by the processor 206 enables the UE 101 to select between a plurality of different position determination approaches. A position determination, relative to the mobile station, can potentially be initiated in one or more of several different ways. At least a couple of examples include a mobile terminated location request (MTLR), a network initiated location request (NILR), and a mobile originated location request (MOLR).

A NILR involves a location request of a mobile station that is initiated by the network, and can often occur in an emergency situation, where in addition to determining the identity of a caller, an emergency call will also trigger an attempt to determine where the caller is located, to assist any emergency assistance operation. An MOLR typically is associated with a location request made by the mobile station user for determining their current location for use by the mobile, which can sometimes be associated with an application being executed on the mobile station, or to communicate their current location to a third party. An MTLR will generally involve a request from a mobile user for information involving the location of a different user. Generally before a mobile user will have access to location information of another mobile user, authorization for access to such information will need to be verified. Regardless as to how the location request is initiated, in the context of at least one cellular environment conforming to the 3G standard, a location request will generally result in a measure position request being conveyed as part of a radio resource control protocol (RRC).

The processor 206 may be configured to select a positioning method based on data received in the RRC Measurement Control message. The following three data fields may be used in the RRC Measurement Control message: a UE-Positioning Method Type: UE-Based; a GPS Assistance Data Component; an AdditionalAssistanceDataRequest Flag. When a UE 101 receives the RRC Measurement Control message with UE-Positioning Method Types as UE-Based, the UE 101 first determines whether there is any GPS Assistance data being delivered in an Assisted GPS (AGPS) Assistance Data Component in this RRC Measurement Control message. Examples of GPS Assistance data include latitude data, longitude data, timing signal data, and other coded signal data related to position determination.

Second, the UE 101 checks the AdditionalAssistanceDataRequest Flag to see whether the UE 101 is allowed to request for GPS Assistance Data. If GPS Assistance Data is provided in the GPS Assistance Data Component, the UE 101 interprets this as a UE-Based AGPS method.

If no GPS Assistance Data is provided in the AGPS Assistance Data Component and if the AdditionalAssistanceDataRequest Flag is turned ON, the UE 101 determines that the 3G network 115 intends to perform a UE-Based Positioning measurement. The UE 101 requests GPS Assistance Data if it is not provided. If the AdditionalAssistanceDataRequest Flag is turn OFF, the UE 101 determines that the 3G network 115 intends to perform a Standalone Positioning measurement. In this case, the UE 101 does not request GPS Assistance data.

By using the optional GPS Assistance Data information and AdditionalAssistanceDataRequest Flag defined in the conventional 3G standard, the 3G network 115 is able to command the UE 101 for the Standalone measurement without modifying the conventional RRC protocol. This ensures backwards compatibility with earlier 3G standards.

The AdditionalAssistanceDataRequest Flag indicates whether the UE 101 can request additional assistance data from 3G network 1 15. With the 3G StandalonePositioning method, the 3G network 115 will be able to maximize a UE's Positioning Capability with any kind of positioning methods. When a Network-Based or UE-Based Location Service is not available, the 3G network 115 can command the UE 101 to perform a Standalone measurement for an emergency call.

The power supply 210 provides power to the components for the UE 101. The power supply 210 is configurable to be controlled by the processor 206 to increase or decrease power to the transmitter 202. The power supply 210 may include power conditioning and power filtering components operable to ensure a smooth power signal to the transmitter 202. The storage 208 stores data required for operation of the UE 101, positioning algorithms and data, channel initialization parameters, and other data used by the processor 206 for operation under 3G protocols. The storage 208 may store other data, such as data packets to be transmitted by the UE 101, data packets received by the receiver 204, or buffered data that is retrieved by the processor 206.

The internal positioning module 212 is coupled with the processor 206 and the storage 208 through the system bus 214. In a preferred embodiment, the internal positioning module 212 may comprise an internal or embedded chipset, such as a GPS chipset. The internal positioning module 212 may comprises source code, software, and/or firmware related to positioning determination, such as embedded algorithms for processing Additional GPS Assistance data provided by the 3G network 115. The internal positioning module 212 may communicate with the 3G network 115 using the positioning receiving antenna 216. In another embodiment, the internal positioning module 212 may also receive coded signals from the 3G network 115 related to longitude, latitude, or timing signals. The internal positioning module 212 may also use other, standalone processes, such as processing data related to the LORAN system or other time and/or location-related signals.

In a preferred embodiment, the external positioning module 218 is coupled with the UE 101 through a wireless RF connection, such as a Bluetooth connection. The external positioning module 218 comprises positioning accessories, such as Bluetooth GPS accessories or components, external RF positioning modules, or receivers coupled with a position determining network such as a LORAN system. The external positioning module 218 may communicate with the UE 101 using the positioning receiving antenna 216. Other connections with the UE 101 may be possible as well. In a preferred embodiment, the external positioning module 218 transmits position data, or data that can be used to derive a position, to the UE 101 when the UE 101 performs a Standalone measurement. The data may be used alone in combination with data from the internal positioning module 212.

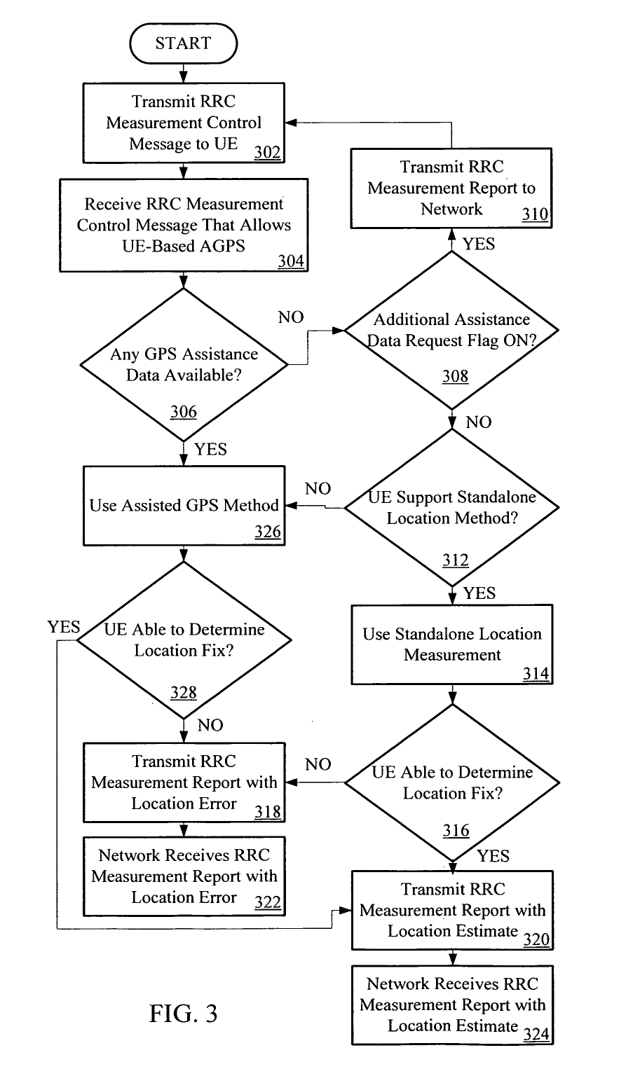

FIG. 3 illustrates example interrelated acts in a process for a position measurement using a user equipment device in a 3G network. In a preferred embodiment, the process illustrated in FIG. 3 implements a fall-back position measurement for a UE in a 3G network. Any of the components described in relation to FIGS. 1-2 may be used to perform the acts illustrated in FIG. 3. A 3G network 115 transmits an RRC Measurement Control Message to an UE 101, at block 302. In a preferred embodiment, the RRC Measurement Control Message includes a Positioning Type command indicating what type of method the 3G network 115 is commanding the UE 101 to perform. In another preferred embodiment, the RRC Measurement Control Message may include GPS Assistance Data for an UE-Based Assisted GPS method, or the RRC Measurement Control Message may indicate a UE-Conventional GPS Method. If the RRC Measurement Control Message indicates an UE-Conventional GPS method, the 3G network 115 does not transmit GPS assistance data to the UE 101, but rather commands the UE 101 to perform an Autonomous GPS method or other standalone location method. The GPS Assistance Data may include latitude, longitude, or timing signal data related to position determination for the UE 101.

The UE 101 receives the RRC Measurement Control Message, at block 304. The RRC Measurement Control Message may allow UE-Based AGPS. The UE 101 may perform error checking operations on the Control Message, and may request a retransmission of the RRC Measurement Control Message if a determined number of errors are indicated in the Control Message. Next, the UE 101 determines whether GPS Assistance data is available from the 3G network 115, at block 306. In a preferred embodiment, if the UE 101 determines that GPS Assistance data is available, the UE 101 next determines if an AdditionalAssistanceDataRequest flag is turned ON, at block 308. The AdditionalAssistanceDataRequest is supported by conventional 3G protocols. If the AdditionalAssistanceDataRequest flag is turned ON, the UE 101 transmits a request, such as an RRC Measurement Report, at block 310, to the 3G network 115, asking for more GPS Assistance Data. The GPS Assistance Data may be transmitted to the UE 101 as latitude data, longitude data, timing data, or other coded signals that assist the UE 101 in determining a position.

If the AdditionalAssistanceDataRequest flag is turned OFF, then it is determined whether the UE 101 supports a Standalone location measurement method, at block 312. If the LJE 101 supports a Standalone location measurement method, the UE 101 then determines a position measurement using a standalone method, at block 314 The UE 101 may access the internal positioning module 212 or the external positioning module 218. The internal positioning module 212 may comprise an embedded GPS chipset or other internal location module. The external positioning module 218 may be coupled with the UE 101 and may comprise a Bluetooth accessory, such as a Bluetooth GPS accessory. The external positioning module 218 may include other external modules, such as RF beacons, LORAN signals, local coded timing signals, WiFi network signals, or other wireless signals that may be used for position determination.

The UE 101 may use the data provided by the internal positioning module 212, including Autonomous GPS data or embedded standalone data from other sources or processes. Data may also be provided by the external positioning module 218, whether separately or in combination, to determine the position of the UE 101. The UE 101 determines, at block 316, whether the UE 101 is able to determine a location fix, based on the data from the internal positioning module 212 and/or the external positioning module 218. If the UE 101 is unable to determine a location fix, the UE 101 transmits a report indicating a location fix error, such as an RRC Measurement Report with a Location Error supported by the 3G standard, at block 318. If the UE 101 is able to determine a location fix, the UE 101 transmits a report with the location fix, such as an RRC Measurement Report with Location Estimate as supported by the 3G standard, at block 320. The 3G network 115 may receive and process the report indicating the location error fix, at block 322, or the report with the location fix, at block 324. The 3G network 115 may request another position measurement from the UE 101, may provide other data to the UE 101, or may locate the UE 101 using other conventional methods.

If the UE 101 determines that GPS Assistance data is available, at block 306, or if the UE 101 does not support Standalone location measurement methods, at block 312, the UE 101 determines a position measurement, at block 326, using an Assisted GPS method. The UE 101 may use GPS Assistance data provided by the 3G network 115, if any is provided by the 3G network 115. The UE 101 may use data such as longitude data, latitude data, timing data, or other coded signal data related to position determination.

The UE 101 determines, at block 328, if a location fix is possible. The UE 101 may perform repetitive UE-based measurements to determine a location fix, or may use a determined error threshold or accuracy/repeatability threshold to determine if a location fix is possible. If the UE 101 is unable to determine a location fix, the UE 101 transmits a report indicating a location fix error, such as an RRC Measurement Report with a Location Error supported by the 3G standard, at block 318. If the UE 101 is able to determine a location fix, the UE 101 transmits a report with the location fix, such as an RRC Measurement Report with Location Estimate as supported by the 3G standard, at block 320. The 3G network 115 may receive and process the report indicating the location error fix, at block 322, or the report with the location fix, at block 324. The 3G network 115 may request another position measurement from the UE 101, may provide other data to the UE 101, or may locate the UE 101 using other conventional methods.

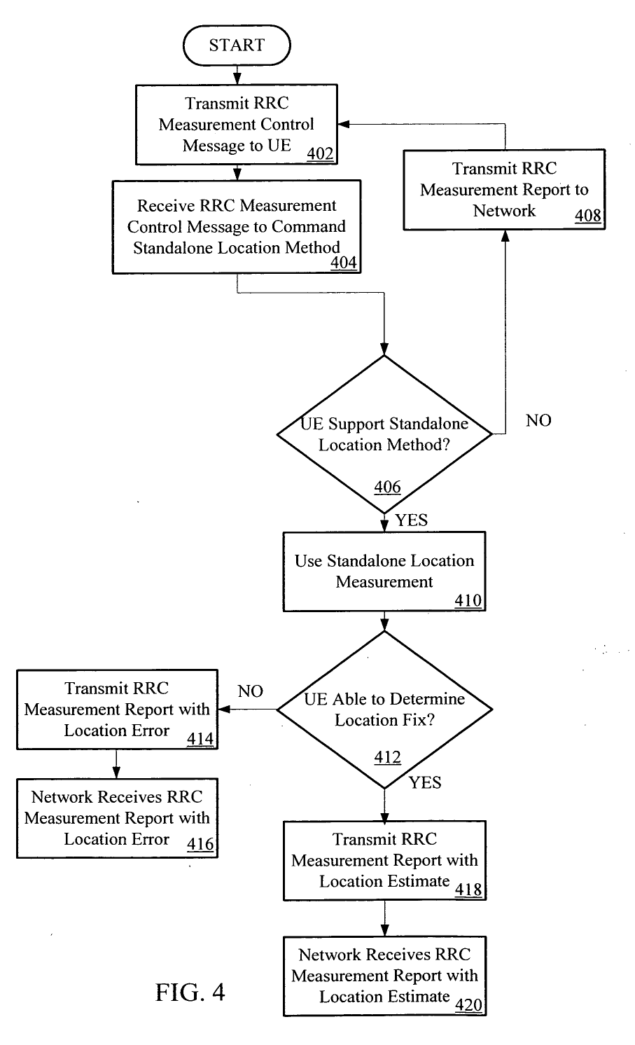

FIG. 4 illustrates example interrelated acts in a process for a standalone position measurement using a user equipment device in a 3G network. Any of the components described in relation to FIGS. 1-2 may be used to perform the acts illustrated in FIG. 4. A 3G network 115 transmits an RRC Measurement Control Message to an UE 101, at block 402. In a preferred embodiment, the RRC Measurement Control Message includes a Positioning Method type command indicating what type of method the 3G network 115 is commanding the UE 101 to perform.

The UE 101 receives the RRC Measurement Control Message that commands a standalone location method, at block 404. The UE 101 may perform error checking operations on the Control Message, and may request a retransmission of the RRC Measurement Control Message if a determined number of errors are indicated in the Control Message. It is next determined whether the UE 101 supports a Standalone location measurement method, at block 406.

If the UE 101 does not support a Standalone location measurement method, the UE 101 transmits an RRC Measurement Report to the 3G network 115, at block 408, indicating that the UE 101 cannot support a Standalone location measurement method, and to request either Assistance Data or other instructions on performing a measurement method. If the UE 101 supports a Standalone location measurement method, the UE 101 then determines a position measurement using a standalone method, at block 410. The UE 101 may access the internal positioning module 212 or the external positioning module 218. The internal positioning module 212 may comprise an embedded GPS chipset or other internal location module. The external positioning module 218 may be coupled with the UE 101 and may comprise a Bluetooth accessory, such as a Bluetooth GPS accessory. The external positioning module 218 may include other external modules, such as RF beacons, LORAN signals, local coded timing signals, WiFi network signals, or other wireless signals that may be used for position determination.

The UE 101 may use the data provided by the internal positioning module 212, including Autonomous GPS data, or data provided by the external positioning module 218, whether separately or in combination, to determine the position of the UE 101. The UE 101 determines, at block 412, whether the UE 101 is able to determine a location fix, based on the data from the internal positioning module 212 and/or the external positioning module 218. If the UE 101 is unable to determine a location fix, the UE 101 transmits a report indicating a location fix error, such as an RRC Measurement Report with a Location Error supported by the 3G standard, at block 414. If the UE 101 is able to determine a location fix, the UE 101 transmiits a report with the location fix, such as an RRC Measurement Report with Location Estimate as supported by the 3G standard, at block 418. The 3G network 115 may receive and process the report indicating the location error fix, at block 416, or the report with the location fix, at block 420. The 3G network 115 may request another position measurement from the UE 101, may provide other data to the UE 101, or may locate the UE 101 using other conventional methods.

The disclosure provides a standalone position method type or standalone position method to positioning Reporting Quantity available in conventional 3G network protocols. A UE in communication with the 3G network may perform a standalone location method when a UTRA Network orders a Standalone positioning method. The LE may use an internal, embedded GPS chipset or an external, Bluetooth accessory to perform the standalone position measurement. The UE also may determine which method to use when there is not enough assistance data provided by the 3G network.

Like the method shown in FIGS. 34, the sequence diagrams may be encoded in a signal bearing medium, a computer readable medium such as a memory, programmed within a device such as one or more integrated circuits, or processed by a controller or a computer. If the methods are performed by software, the software may reside in a memory resident to or interfaced to the UE 101, a communication interface, or any other type of non-volatile or volatile memory interfaced or resident to the UE 101, or the BS 110. The memory may include an ordered listing of executable instructions for implementing logical functions. A logical function may be implemented through digital circuitry, through source code, through analog circuitry, or through an analog source such as through an analog electrical, audio, or video signal. The software may be embodied in any computer-readable or signal-bearing medium, for use by, or in connection with an instruction executable system, apparatus, or device. Such a system may include a computer-based system, a processor-containing system, or another system that may selectively fetch instructions from an instruction executable system, apparatus, or device that may also execute instructions.

A “computer-readable medium,” “machine-readable medium,” “propagated-signal” medium, and/or “signal-bearing medium” may comprise any module that contains, stores, communicates, propagates, or transports software for use by or in connection with an instruction executable system, apparatus, or device. The machine-readable medium may selectively be, but not limited to, an electronic, magnetic, optical, electromagnetic, infrared, or semiconductor system, apparatus, device, or propagation medium. A non-exhaustive list of examples of a machine-readable medium would include: an electrical connection “electronic” having one or more wires, a portable magnetic or optical disk, a volatile memory such as a Random Access Memory “RAM” (electronic), a Read-Only Memory “ROM” (electronic), an Erasable Programmable Read-Only Memory (EPROM or Flash memory) (electronic), or an optical fiber (optical). A machine-readable medium may also include a tangible medium upon which software is printed, as the software may be electronically stored as an image or in another format (e.g., through an optical scan), then compiled, and/or interpreted or otherwise processed. The processed medium may then be stored in a computer and/or machine memory.

While the principles of the invention have been described above in connection with specific apparatus, it is to be clearly understood that this description is made only by way of example and not as a limitation on the scope of the invention. It is therefore intended that the foregoing detailed description be regarded as illustrative rather than limiting, and that it be understood that it is the following claims, including all equivalents, that are intended to define the spirit and scope of this invention.

1. A communications device for a third generation (3G) network comprising a user equipment (UE) processor configured to execute instructions to determine a standalone location based on a radio resource control (RRC) measurement control message, wherein the UE processor of the communication device receives a standalone command to use a standalone location process from the RRC measurement control message, and wherein the UE processor is configured to determine the standalone location using an internal positioning module or an external positioning module.

2. The communications device of claim 1, wherein the internal positioning module comprises an embedded GPS chipset operatively coupled with the UE processor.

3. The communications device of claim 1, wherein the external positioning module comprises a GPS accessory operatively coupled with the communications device.

4. The communications device of claim 1, wherein the external positioning module comprises a GPS accessory.

5. The communications device of claim 1, wherein the UE processor is configured to determine the standalone location using at least one of autonomous GPS data or an embedded standalone process when the UE processor receives the standalone command.

6. The communications device of claim 1, wherein the UE processor is configured to use data from the external positioning module to determine the standalone location when the UE processor receives the standalone command and when the UE processor does not process autonomous GPS data or an embedded standalone process.

7. A communications device for a third generation (3G) network comprising a user equipment (UE) processor configured to determine a standalone location based on a radio resource control (RRC) measurement control message, wherein the UE processor is configured to receive a UE-Based location determination command or a UE-Based-Preferred location determination command, and wherein an additional assistance data request parameter has a value of off, and when the UE processor receives location assistance data, the UE processor is configured to use UE-Based data to determine a location of the communications device, and when the UE processor is unable to determine the location based on the location assistance data, the UE processor is configured to use a standalone location process to determine the location.

8. The communications device of claim 7, wherein when the UE processor does not receive the assistance data, the UE processor is configured to use the standalone location process to determine the location of the communications device.

9. A communications device for a third generation (3G) network comprising a user equipment (UE) processor configured to determine a standalone location based on a radio resource control (RRC) measurement control message, wherein the UE processor is not commanded to use a standalone location method, and wherein the UE processor is configured to determine the standalone location with an internal positioning module or an external positioning module.

10. The communications device of claim 9, wherein the internal positioning module comprises an embedded GPS chipset.

11. The communications device of claim 9, where the external positioning module comprises a GPS accessory operatively coupled with the communications device.

12. The communications device of claim 9, wherein the UE processor is configured to determine the standalone location using at least one of autonomous GPS data or an embedded standalone process when the UE processor determines the location.

13. The communications device of claim 9, wherein the UE processor is configured to use data from the external positioning module to determine the standalone location when the UE processor does not use autonomous GPS data or an embedded standalone process.

14. A method for determining a location of a communications device in a 3G network, the method comprising:
receiving a standalone positioning command command at a user equipment (UE), wherein the standalone positioning type command indicates that the UE is configured to determine a UE location using a standalone process; and
determining the UE location using data from an internal positioning module or external data.

15. The method of claim 14, wherein determining the UE location comprises using data from an embedded GPS chipset.

16. The method of claim 15, wherein determining the UE location comprises using data from a GPS accessory in communication with the UE.

17. A method that determines a location of a communications device in a third generation (3G) network, the method comprising:
receiving a user equipment (UE)-Based method type command or a UE-BasedPreferred position method type command at a UE device;
determining an additional assistance data request parameter, wherein the UE device is configured to not request additional assistance data if the additional assistance data request parameter is set to an off value;
determining if assistance data is received by the UE device; and
determining the location of the UE device using a standalone process when no assistance data is received by the UE device.

18. The method of claim 17, wherein determining the location of the UE device using a standalone process comprises using data from an internal positioning module or an external accessory.

19. The method of claim 17, wherein the internal positioning module comprises a GPS chipset operatively coupled with the UE device.

20. The method of claim 17, wherein the external accessory comprises a GPS accessory in communication with the UE device.

21. The method of claim 17, further comprising transmitting the location of the UE device after determining the location.

22. A third generation (3G) (UE) device comprising at least one of an internal positioning module and an external accessory coupled with the UE device, the UE device configured to a receive a radio resource control (RRC) measurement control message, the RRC measurement control message adaptable to command the UE device to perform a standalone positioning determination using data from at least one of the internal positioning determining module or the external accessory to determine a location of the UE device.

23. The 3G UE device of claim 22, wherein the internal positioning module comprises an embedded GPS chipset coupled with the UE device.

24. The 3G UE device of claim 22, wherein the external accessory comprises a GPS accessory in communication with the UE device.

25. The 3G UE device of claim 22, wherein the UE device is configured to determine the location with at least one of autonomous GPS data or an embedded standalone process when the UE processor receives the standalone positioning type.

26. The 3G UE device of claim 25, wherein the UE device is configured to use data from the external positioning module to determine the location when the UE device is commanded to perform the standalone positioning determination and when the UE does not use the autonomous GPS data or the embedded standalone process.

27. The 3G UE device of claim 22, wherein the UE device is configured to receive a UE-Based location determination command or a UE-Based-Preferred location determination command, and wherein an additional assistance data request parameter has a value of off, and when the UE device receives location assistance data, the UE device is configured to use UE-Based data to determine a location of the communications device, and when the UE device is unable to determine the location due to limited assistance data, the UE device uses a standalone location process to determine the location.

28. The 3G UE device of claim 22, wherein when the UE device is not commanded to perform the standalone positioning determination, the UE device is configured to determine the standalone location with the internal position determining module or the external accessory.
